(19) United States
(12) Patent Application Publication
(10) Pub. No.: US 2003/0169813 A1
(43) Pub. Date: Sep. 11, 2003

(54) Method and apparatus to execute a smooth transition between FGS encoded structures

(76) Inventor: Mihaela Van Der Schaar, Ossining, NY (US)

Correspondence Address: PHILIPS INTELLECTUAL PROPERTY & STANDARDS, P.O. BOX 3001, BRIARCLIFF MANOR, NY, 10510, US

(21) Appl. No.: 10/094,123

(22) Filed: Mar. 8, 2002

(51) Int. Cl. H04N 7/12

(52) U.S. Cl. 375/240.12; 375/240.01

(57) ABSTRACT

A method and apparatus for providing a smooth transition of the transmission over a network between a first FGS encoded video stream and a second FGS encoded video stream wherein each of the FGS encoded video streams contains a base layer. The method comprises selecting a transmitted P-frame of the first video stream, selecting a next P-frame to be transmitted in the second video stream, determining a difference between the transmitted P-frame of the first video stream and the next to be transmitted P-frame of the second video-stream, and transmitting the difference between said P-frames over said network in place of said next to be transmitted P-frame.

### RELATED APPLICATIONS

This application is related to commonly assigned:

U.S. patent application Ser. No. ______, entitled “Single Loop Motion-Compensation Fine Gradular Scalability”, filed on Jun. 22, 2001, which is incorporated herein by reference herein.

### FIELD OF THE INVENTION

This application is related to Fine Granular Scalability (FGS) video encoding and, more specifically, to a method and apparatus for providing a smooth transition when switching between different images which are FGS encoded.

### BACKGROUND OF THE INVENTION

To accommodate a wide range of transmission bit-rates, a video source may be encoded using a plurality of FGS encoded structures that are representative of different transmission bit rates and levels of motion compensation (MC). Each encoded video structure may be stored in a permanent or semi-permanent media that allows for their subsequent selection to match the available network bandwidth. As an example, a video image may be FGS encoded in a structure that contains a base layer encoded at a first rate, represented as R1, and an enhancement layer encoded up to a rate represented as R11. The video image may then be encoded using a second FGS encoded structure that contains a base layer encoded at rate R11 and an enhancement layer encoded up to a rate represented as R12. The video image may further be FGS encoded in a third structure that contains a base layer at rate R12 and an enhancement layer encoded up to a rate represented as R13. In this manner, an FGS encoded structure may be selected to allow for the transmission of the video image over a network, i.e., a video stream, at a maximum transmission bit-rate that matches the available network bandwidth.

However, characteristics of the network, such as available network bandwidth, may dynamically change during the transmission of a video image. The available network bandwidth may substantially be reduced as users enter the network or may substantially increase as users exit the network. Hence, the transmission of the video stream must adapt to the changing conditions. As the network characteristics change, for example, a substantial decrease in the network bandwidth, the video stream may require a base layer with a substantially lower bit-rate, otherwise information may be lost. Similarly, should the available network bandwidth increase, a base layer with a substantially higher bit-rate may be allowed to provide an increase in image resolution. Thus, as the network operating characteristics change or are altered, a transition between FGS encoded structures representative of different bit-rate transmission versions of the video image is necessary to maintain a maximum bit-rate for the available network bandwidth. Similarly, changes in the available network bandwidth may create the need for a transition from one motion-compensated FGS (MC-FGS) encoded video structure to another MC-FGS encoded structure or to a FGS encoded structure. Such a transition may be necessary when, for example, an error occurs within the FGS-enhancement layer data used for base layer prediction. In this case, the introduced error will accumulate until the next I-frame is transmitted.

Transitioning between FGS encoded structures or versions of different bit-rates of the video image conventionally requires the introduction of a bandwidth expansive I-frame to establish a reference in the FGS version or structure being transitioned to. I-frame transmission is expensive in terms of bandwidth as a full frame of image information is required to be transmitted. The introduction of a bandwidth expensive I-frame during a transition between FGS and/or MCFGS encoded structures burdens the network as valuable network resources are used.

Hence, there is a need for a method and system to execute a smooth transition between FGS encoded structures and/or between of MC-FGS encoded structures without the need for bandwidth expensive I-frame transmission.

### BRIEF DESCRIPTION OF THE FIGURES

FIG. 1 illustrates an FGS encoding/decoding system in accordance with the principles of the present invention;

FIG. 2 illustrates a flow chart of an exemplary process in accordance with the principles of the present invention;

FIG. 3 illustrates an exemplary transition between two FGS encoded image structures;

FIG. 4 illustrates an exemplary transition between two MC-FGS encoded image structures;

FIG. 5a illustrates a flow chart of an exemplary process for determining S-frames in accordance with the principles of the invention;

FIG. 5b illustrates a flow chart of a second exemplary process for determining S-frames in accordance with the principles of the invention; and

FIG. 6 illustrates an exemplary system for practicing the principles of the present invention.

It is to be understood that these drawings are solely for purposes of illustrating the concepts of the invention and are not intended as a level of the limits of the invention. It will be appreciated that the same reference numerals, possibly supplemented with reference characters where appropriate, have been used throughout to identify corresponding parts.

### SUMMARY OF THE INVENTION

A method and apparatus for providing a smooth transition of the transmission over a network between a first FGS encoded video stream and a second FGS encoded video stream wherein each of the FGS encoded video stream contains a base layer. The method comprises selecting a transmitted P-frame of the first video stream, selecting a next P-frame to be transmitted in the second video stream, determining a difference between the transmitted P-frame of the first video stream and the next to be transmitted P-frame of the second video-stream, and transmitting the difference between said P-frames over said network in place of said next to be transmitted P-frame.

### DETAILED DESCRIPTION OF THE INVENTION

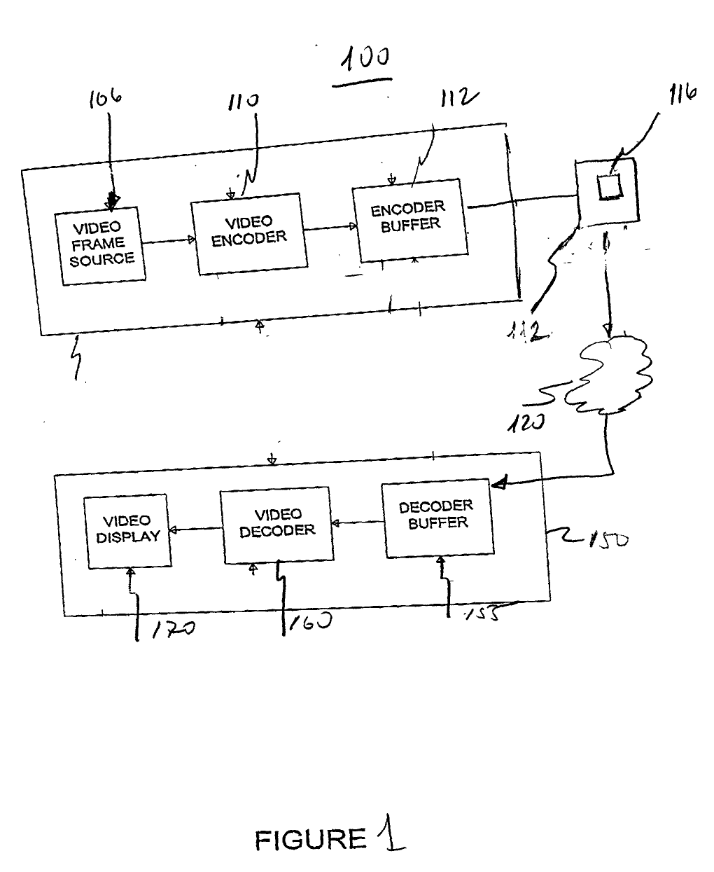

FIG. 1 illustrates an exemplary system for FGS encoding/decoding 100 wherein video image 106 is applied to encoder 110 for FGS encoding. Encoder 110 may encode video image 106 using a plurality of different bit-rates and different MC-FGS levels. In one aspect of the invention, the encoded information may be stored in buffer 112. Transmission controller 120 provides a means for controlling the transmission rate of FGS encoded information over network 120 by selecting one of the stored FGS or MC-FGS encoded structures. Network 120 may be representative of a communication network such as the Internet, POTS, LAN, WAN, Intranet, wireless network, etc.

Decoding unit 150 receives the FGS encoded information transmitted over network 120 and may optionally store the received information in decoder buffer 155. The received information may be applied directly, or from decoder buffer 155, to decoder 160 for decoding into video images. The decoded images may subsequently be presented on display 170. In this exemplary system, processor 116 within transmission controller 112, is representative of a means for monitoring network characteristics, such as available bandwidth, and provides an indication to assist in the determination of which of the stored FGS encoded information structures are selected for transmission over network 120.

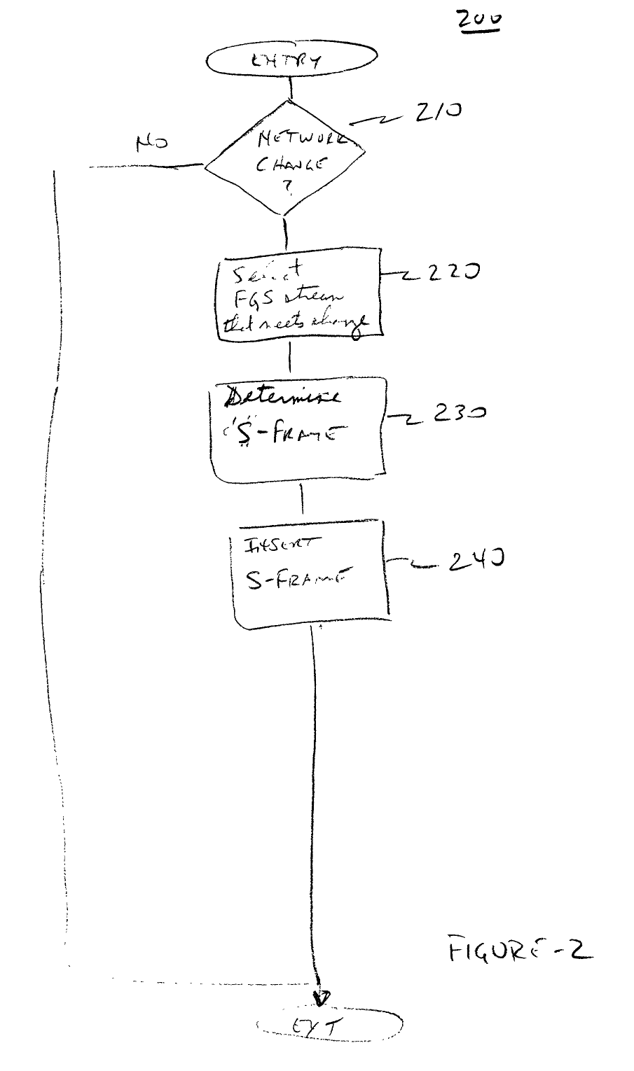

FIG. 2 illustrates a flow chart of an exemplary process 200 for providing a transition between FGS encoded structures of different bit-rate streams and/or MC-FGS encoded structures of different levels of motion compensation in accordance with the principles of the invention. In this exemplary process, a determination is made at block 210 whether a network characteristic, e.g., available bandwidth, has changed. If the answer is negative, then no transition is necessary and processing is completed without a transition occurring.

However, if the answer is affirmative, then at block 220 a determination is made regarding which of the stored FGS or MC-FGS structures or versions of bit-rate transmission satisfies the changed network conditions. At block 230, an intermediate-switching frame 235, referred to herein as an S-frame, is determined as a difference between the previously transmitted P-frame and the next P-frame of the selected FGS encoded image structure.

At block 240 S-frame 235 is inserted in the transmission stream instead of the transmission of the next P-frame of the selected FGS encoded image structure. Although stored FGS encoded image structures or MC-FGS encoded levels are descried herein to illustrate the invention, it should be understood that FGS encoding may similarly be performed in real-time. Consequently, in an alternative aspect of the invention, the difference between a previously transmitted P-frame and a next P-frame may be determined in real-time.

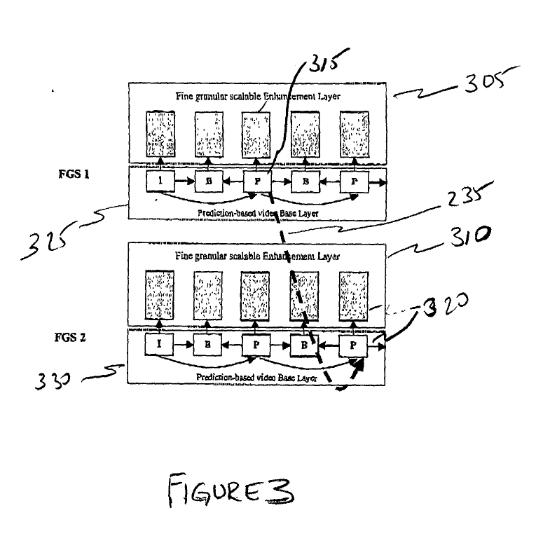

FIG. 3 illustrates an example of a transition between two video streams 305, 310 that are FGS encoded using different bit rates and the insertion of S-frame 235 to accomplish a smooth transition between streams 305, 310 in accordance with the principles of the invention. In this illustrative example, a transition from a first FGS encoded video stream 305, e.g., lower bit-rate, lower resolution or frame-rate, to a second FGS encoded video structure 310, e.g., higher bit-rate, higher resolution or frame-rate, is depicted. In this case, when a transition from FGS encoded structure 305 to FGS encoded structure 310 is deemed necessary, S-frame 235 is determined as the difference between next P-frame 320 of FGS encoded structure 310 and previously transmitted base-layer P-frame 315 of FGS encoded video structure 305. S-frame 235 is then transmitted instead of P-frame 320. Subsequent image transmission in P-frames occurs in accordance with the images included in FGR encoded structure 310. Furthermore, S-frame 235 is transmitted instead of a B-frame preceding P frame 320. Synchronization with FGS encoded stream 310 is thus completed without the expanse of an I-frame transmission and consequential bandwidth cost. Although the illustrative example does not include motion-compensation, and S-frame 235 includes only information regarding the difference in base layers of each of the respective FGS structures, it would be understood that the determination of S-frame 235 as the difference between base layer P-frames would similarly be applicable to a transition between an MC-FGS structure (not shown) and FGS structure 310, for example. In this case, S-frame 235 is inserted in the transmission stream instead of the transmission of P-frame 320.

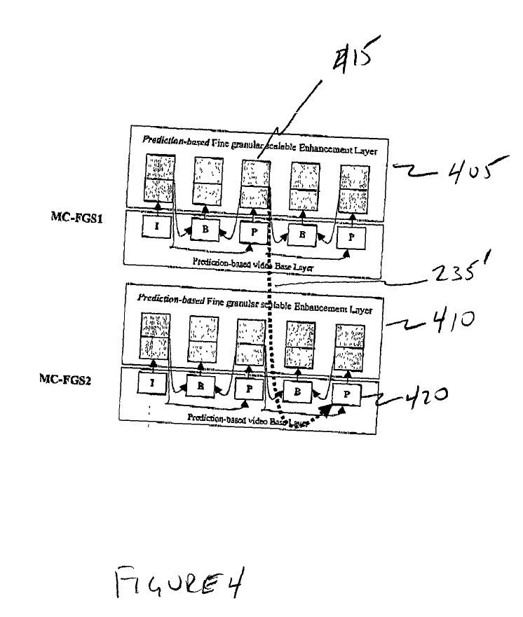

FIG. 4 illustrates an example of a transition between two video streams 405, 410 having MC-FGS structures of different levels of motion compensation information. In this illustrative example, a transition from video stream 405, which MC-may be MC-FGS encoded at a first level to video stream 410, which is MC-FGS encoded at a second level, is necessary. In this case, S-frame 235′ is determined as the difference between respective base layer information and that portion of the corresponding FGS enhancement layer included in for motion compensation. In this case, S-frame 235′ is determined as the difference between base layer next P-frame 420 of MC-FGS structure 410 and previously transmitted base-layer P-frame 415 of MC-FGS structure 405 and corresponding FGS enhancement layers. S-frame 235′ is then transmitted instead of next P-frame 420 to accomplish a smooth transition between respective video streams.

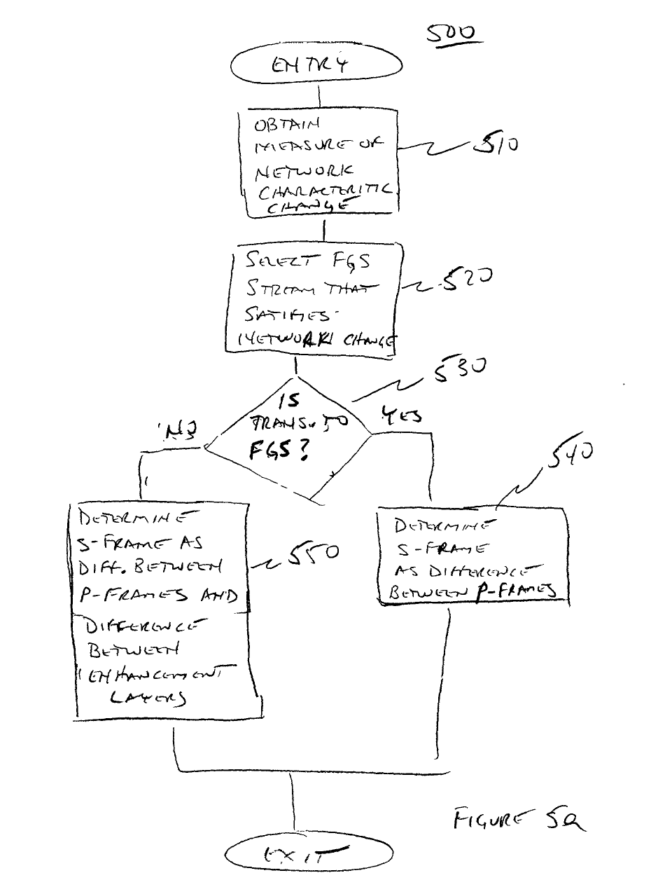

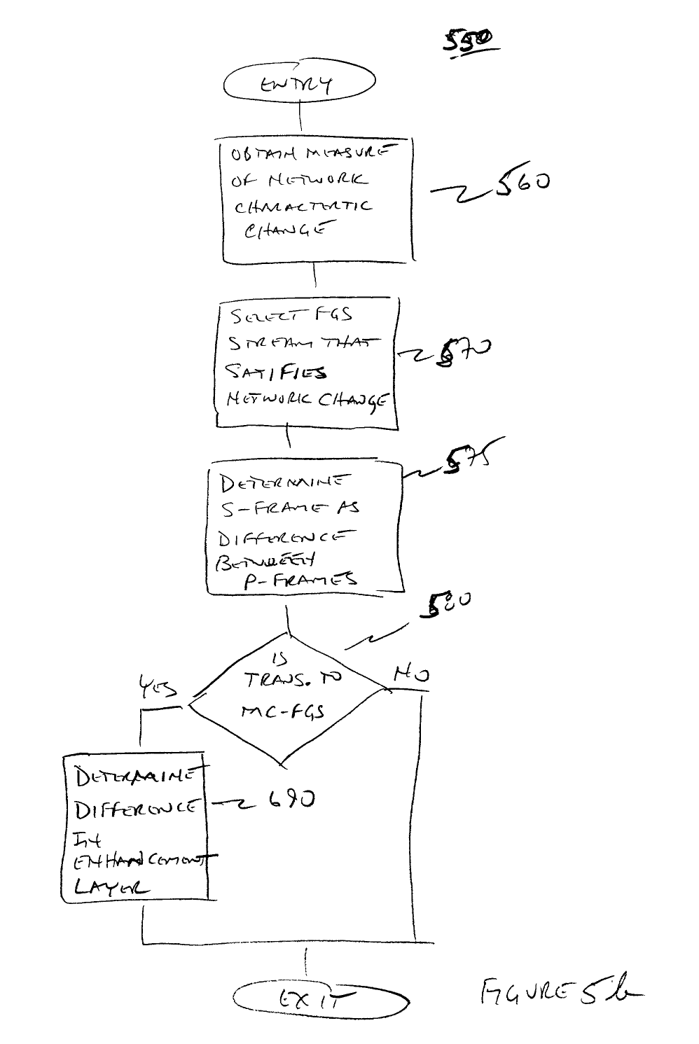

FIG. 5a illustrates a flow chart of an exemplary process 500 for the determination of an S-frame 235 or 235′ in accordance with the principles of the present invention. In this exemplary process, a measure of a change in a network characteristic, e.g., available bandwidth, is obtained at block 510. At block 520, a stored FGS encoded video image structure is selected that satisfies the conditions of the change in network characteristic. At block 530 a determination is made whether the desired transition is from an FGS structure or an MC-FGS structure to an FGS structure. If the answer is affirmative, then S-frame 235 is determined as the difference between base-layer P-frames of the previous and the selected FGS encoded structure.

However, if the answer is negative, the S-frame 235′ is determined as the difference between base layer P-frames and the difference between those enhancement layers portions used for prediction. That is, the difference in those enhancement layer portions used for motion prediction supplements the difference between P-frames information. In one aspect of the invention, the difference in base layer P-frames may be determined by determining a difference of P-frames in the pixel domain and then encoding this difference using well-known base layer texture coding, i.e., DCT, discrete Q and VLC. Similarly, the difference in the enhancement layer may be determined by determining the difference in those portions of the enhancement layer used for prediction of motion by computing a difference in the pixel domain and then encoding this difference using FGS coding, i.e., DCT, and then bit-plane coding & VLC.

FIG. 5b illustrates a flow chart of an exemplary second process 550 for the determination of an S-frame 235, 235′ in accordance with the principles of the present invention. In this exemplary process, a measure of a change in network characteristic, e.g., available bandwidth, is obtained at block 560. At block 570 a stored FGS encoded structure of a video image is selected that satisfies the conditions of the change in network characteristic. At block 575, S-frame 235 is determined as the difference between base layer P-frames as previously described.

At block 580 a determination is made whether the transition is between FGS encoded or MC-FGS encoded structures and an FGS structure. If the answer is in the affirmative, then process 550 ends at block 560.

However, if the answer is in the negative, the S-frame 235′ is determined by supplementing S-frame 235 with a quantity that is representative of a difference between portions of corresponding enhancement layers as previously described.

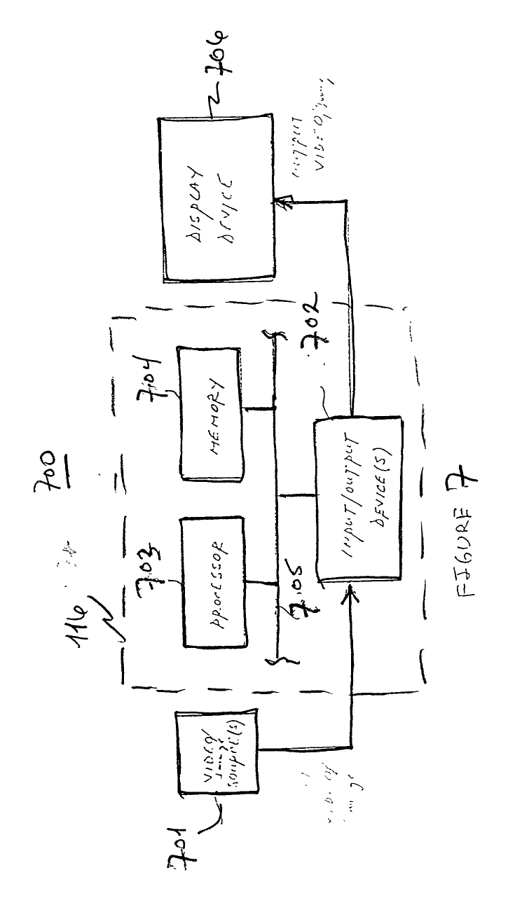

FIG. 6 illustrates an exemplary embodiment of a system 700 that may be used for implementing the principles of the present invention. System 700 may represent a desktop, laptop or palmtop computer, a personal digital assistant (PDA), a video/image storage apparatus such as a video cassette recorder (VCR), a digital video recorder (DVR), a TiVO apparatus, etc., as well as portions or combinations of these and other devices. System 700 may contain one or more input/output devices 702, processors 703 and memories 704, which may access one or more sources 701 that contain FGS encoded structures of video images. Sources 701 may be stored in permanent or semi-permanent media such as a television receiver, a VCR, RAM, ROM, hard disk drive, optical disk drive or other video image storage devices. Sources 701 may alternatively be accessed over one or more network connections for receiving video from a server or servers over, for example a global computer communications network such as the Internet, a wide area network, a metropolitan area network, a local area network, a terrestrial broadcast system, a cable network, a satellite network, a wireless network, or a telephone network, as well as portions or combinations of these and other types of networks.

Input/output devices 702, processors 703 and memories 704 may communicate over a communication medium 706. Communication medium 706 may represent for example, a bus, a communication network, one or more internal connections of a circuit, circuit card or other apparatus, as well as portions and combinations of these and other communication media. Input data from the sources 701 is processed in accordance with one or more software programs that may be stored in memories 704 and executed by processors 703 in order to supply FGS encoded video images to network 120 (not shown). Processors 703 may be any means such as general purpose or special purpose computing system, or may be a hardware configuration, such as a laptop computer, desktop computer, handheld computer, dedicated logic circuit, integrated circuit, Programmable Array Logic (PAL), Application Specific Integrated Circuit (ASIC), etc., that provides a known output in response to known inputs. Furthermore, processors 703 may include means responsive to changes in network 120 or may contain code that is operable to determine changes in the operational characteristics of network 120. In one aspect of the invention, changes in network may be provided to processor 703 by input/output devices 703, automatically or in response to a request initiated by processors 703.

In a preferred embodiment, the coding and decoding employing the principles of the present invention may be implemented by computer readable code executed by processor 703. The code may be stored in the memory 704 or read/downloaded from a memory medium such as a CD-ROM or floppy disk. In other embodiments, hardware circuitry may be used in place of, or in combination with, software instructions to implement the invention. For example, the elements illustrated herein may also be implemented as discrete hardware elements.

Although the invention has been described in a preferred form with a certain degree of particularity, it is understood that the present disclosure of the preferred form has been made only by way of example, and that numerous changes in the details of construction and combination and arrangement of parts may be made without departing from the spirit and scope of the invention as hereinafter claimed. It is intended that the patent shall cover by suitable expression in the appended claims, those features of patentable novelty that exist in the invention disclosed.

What is claimed is:

1. A method for smoothly transitioning between a first FGS encoded video stream and a second FGS encoded video stream wherein each of said FGS encoded video streams contains a base layer, said method comprising the steps of:
selecting a P-frame of said first video stream transmitted over a network;
selecting a next P-frame to be transmitted over said network in said second video stream;
determining a difference between said transmitted P-frame of said first video stream and said next P-frame to be transmitted of said second video-stream; and
transmitting said difference between said P-frames instead of said next P-frame to be transmitted over said network.

2. The method as recited in claim 1, wherein said each of said FGS encoded video streams includes at least one enhancement layer.

3. The method as recited in claim 2, further comprising the step of:
selecting a portion of said at least one enhancement layer transmitted in said first video stream;
selecting a portion of said at least one enhancement layer to be transmitted in said second video stream;
determining a difference between said selected portions of said enhancement layers; and
transmitting said difference over said network.

4. The method as recited in claim 1, wherein the step of determining a difference in said P-frames comprises the steps of:
decoding each of said P-frames;
determining a difference between said P-frames; and
encoding said difference.

5. The method as recited in claim 3, wherein the step of determining a difference in said selected portions of said enhancement layer comprises the step of:
decoding each of said selected portions of said enhancement layers;
determining a difference between decoded selected portions; and
encoding said difference.

6. The method as recited in claim 1, wherein said second video stream is selected to obtain a maximum base layer rate of transmission comparable to said network bandwidth.

7. The method as recited in claim 1, wherein said second video stream is selected to obtain a maximum level of motion compensation.

8. An apparatus for smoothly transitioning between a first FGS encoded video stream and a second FGS encoded video stream wherein each of said FGS encoded video streams contains a base layer, said apparatus comprising:
means for selecting a P-frame of said first video stream transmitted over a network;
means for selecting a next P-frame to be transmitted over said network in said second video stream;
means for determining a difference between said transmitted P-frame of said first video stream and said next P-frame to be transmitted of said second video-stream; and
means for transmitting said difference between said P-frames instead of said next P-frame to be transmitted over said network.

9. The apparatus as recited in claim 8, wherein each of said FGS encoded video streams includes at least one enhancement layer.

10. The apparatus as recited in claim 9, further comprising:
means for selecting a portion of said at least one enhancement layer transmitted in said first video stream;
means for selecting a portion of said at least one enhancement layer to be transmitted in said second video stream;
means for determining a difference between said selected portions of said enhancement layers; and transmitting said enhancement layer difference over said network.

11. The apparatus as recited in claim 8, wherein determining a difference between said P-frames comprises executing code for:
decoding each of said P-frames;
determining a difference between said P-frames; and
encoding said difference.

12. The apparatus as recited in claim 10, wherein determining a difference between said selected portions of said enhancement layer comprises executing code for:
decoding each of said selected portions of said enhancement layers;
determining a difference between decoded selected portions; and
encoding said difference.

13. The apparatus as recited in claim 8, wherein said second video stream is selected to obtain a maximum base layer rate of transmission comparable to said network bandwidth.

14. The apparatus as recited in claim 8, wherein said second video stream is selected to obtain a maximum level of motion compensation.

15. The apparatus as recited in claim 8, further comprising:
an input/output apparatus in communication with said processor and said memory.

16. The apparatus as recited in claim 8, wherein said code is stored in said memory.

17. An S-Frame of an FGS encoded video stream comprising:
a difference between a transmitted P-frame of a first video stream and a next P-frame to be transmitted of a second video-stream.

18. The S-Frame as recited in claim 17, wherein said each of said FGS encoded video streams includes at least one enhancement layer.

19. The S-Frame as recited in claim 18, further comprising:
a difference between said selected portions of said enhancement layers.
